(19) United States
(12) Patent Application Publication
(10) Pub. No.: US 2026/0319512 A1
(43) Pub. Date: Oct. 15, 2026

(54) METHOD FOR GENERATING OPTIMAL TRAVELING PATH OF ROBOT BASED ON FLOOR CONDITION, ROBOT, AND PROGRAM

(71) Applicant: DOGU CO., LTD., Daegu (KR)

(72) Inventors: Cheng Hao Quan, Seoul (KR); Quoc Huy Tran, Seoul (KR); Jin Hyo Kim, Sokcho-si, Gangwon-do (KR)

(73) Assignee: DOGU CO., LTD., Daegu (KR)

(21) Appl. No.: 18/861,998

(22) PCT Filed: Sep. 26, 2024
(86) PCT No.: PCT/KR2024/014593

§ 371 Date: Oct. 31, 2024

(30) Foreign Application Priority Data
Dec. 27, 2023 (KR) 10-2023-0192632
Sep. 23, 2024 (KR) 10-2024-0128446

(51) Int. Cl. G05D 1/644

(52) U.S. Cl. CPC G05D 1/644

(57) ABSTRACT

A method for generating an optimal traveling path of a robot based on a floor condition according to the present invention may include: generating a plurality of traveling path candidates from position of the robot to a destination; calculating traveling scores of the traveling path candidates; and generating the optimal traveling path based on the traveling scores.

### TECHNICAL FIELD

The present invention relates to a technology for generating a traveling path of a robot, and more specifically, to a technology for generating an optimal traveling path of a robot based on a floor condition.

### BACKGROUND ART

Hitherto, technologies for planning a traveling path of a robot have been studied and developed in various fields. Mainly for industrial robots or service robots, a technology for moving along a preset path or avoiding obstacles while modifying a path in real time has been widely used. Such a path planning technology has been designed to recognize an environment by using a sensor such as a global positioning system (GPS), a light detection and ranging (LIDAR), or a camera, and to enable a robot to efficiently move to a destination based on the recognized environment.

In the technology according to the related art, the focus was mainly on the shortest distance or energy efficiency when calculating a movement path of a robot. In other words, a method which searches for the fastest path for the robot to reach a destination or generates a path that minimizes battery consumption has been used. Although such a method may theoretically provide an efficient path, road conditions or floor conditions in an actual traveling environment are not sufficiently considered in many cases.

For example, when the robot is traveling on a slippery floor or uneven terrain, simply selecting the shortest path can cause problems such as decreased traveling safety, motor overload, and increased energy consumption of the robot. In particular, when the robot travels on various floors such as slopes, mudflats, gravel roads, and snow-covered ground, traveling performance of the robot significantly deteriorates, and in such environments, the risk of the robot slipping or colliding with an obstacle increases, which makes it difficult to achieve both safety and efficiency in driving.

In addition, a robot path planning system according to the related art assumes a static environment, and thus is not able to immediately reflect changing floor conditions in real time. In particular, when the floor condition rapidly changes due to rain or snow in outdoor environments, the robot is unable to properly detect and respond to the change, which increases a possibility that a problem occurs on the path.

For example, in a case where a normally travelable path turns into mud due to rain and becomes slippery, the robot may not continue to traveling on the path. In order to travel safely on the path in such a changing environment, a technology for detecting a floor condition in real time and immediately modifying a path accordingly is needed.

To solve such problems, a technology for generating an optimal traveling path of a robot based on a floor condition has been demanded.

### DISCLOSURE

### Technical Problem

An object of the present invention is to propose a method for generating an optimal path of a robot based on a floor condition, a robot, and a program.

Objects of the present invention are not limited to the above-mentioned object, and other objects and advantages of the present invention that are not mentioned may be understood by the following description and will be more clearly appreciated by exemplary embodiments of the present invention. In addition, it may be easily appreciated that objects and advantages of the present invention may be realized by means mentioned in the claims and a combination thereof.

### Technical Solution

According to an exemplary embodiment of the present invention, a method for generating an optimal traveling path of a robot based on a floor condition includes: generating a plurality of traveling path candidates from a position of the robot to a destination; calculating traveling scores of the traveling path candidates; and generating the optimal traveling path based on the traveling scores.

The calculating of the traveling scores may include classifying types of traveling roads included in the traveling path candidates.

The calculating of the traveling scores may further include determining whether or not there is a road that is unusable by the robot among the classified types of traveling roads.

The calculating of the traveling scores may further include regenerating a traveling path candidate based on whether or not there is a road that is unusable by the robot in the traveling path candidates.

The calculating of the traveling scores may further include associating an expected motor current change value of the robot with each classified type of traveling road.

The calculating of the traveling scores may further include calculating the traveling scores of the traveling path candidates based on the expected motor current change value.

According to another exemplary embodiment of the present invention, a robot that generates an optimal traveling path based on a floor condition includes: a path generation unit generating a plurality of traveling path candidates from a position of the robot to a destination, calculating traveling scores of the traveling path candidates, and generating the optimal traveling path based on the traveling scores.

The path generation unit may classify types of traveling roads included in the traveling path candidates.

The path generation unit may determine whether or not there is a road that is unusable by the robot among the classified types of traveling roads.

The path generation unit may regenerate a traveling path candidate based on whether or not there is a road that is unusable by the robot in the traveling path candidates.

The path generation unit may associate an expected motor current change value of the robot with each classified type of traveling road.

The path generation unit may calculate the traveling scores of the traveling path candidates based on the expected motor current change value.

According to another exemplary embodiment of the present invention, a computer program stored in a computer-readable recording medium includes a program code for executing the method for generating an optimal traveling path described above.

According to another embodiment of the present invention, a computer-readable recording medium records a computer program for executing the method for generating an optimal traveling path described above.

### Advantageous Effects

According to the present invention, an optimal traveling path of the robot may be generated by considering a floor condition.

According to the present invention, real-time weather information or a road condition may be reflected when generating a path, and thus, a slippery road or flooded area caused by rain, snow, wind, or the like may be avoided, thereby improving traveling safety.

In addition, the present invention may estimate an accurate position by utilizing various sensor data in addition to a GPS signal.

Further, the present invention may accurately predict a motor current consumption by considering changes in floor condition, gradient, weather, or the like on the path, and select an optimal path based on the predicted motor current consumption.

Effects of the present invention are not limited to the effects described above, and other effects that are not mentioned may be obviously understood by those skilled in the art from the following description.

### DESCRIPTION OF DRAWINGS

FIGS. 1 and 2 are views illustrating a robot according to an exemplary embodiment of the present invention.

FIG. 3 is a diagram illustrating a configuration of a robot control system according to an exemplary embodiment of the present invention.

FIG. 4 is a diagram illustrating a configuration of the robot according to an exemplary embodiment of the present invention.

FIG. 5 is a diagram illustrating a map generation method according to an exemplary embodiment of the present invention.

FIG. 6 is a diagram illustrating some of maps described in FIG. 5.

FIG. 7 is a diagram illustrating a map generation method according to an exemplary embodiment of the present invention.

FIGS. 8 to 10 are flowcharts illustrating a method for generating an optimal path based on floor condition according to an exemplary embodiment of the present invention.

### BEST MODEL

The following description illustrates only a principle of the present invention. Therefore, those skilled in the art may implement the principle of the present invention and invent various apparatuses included in the spirit and scope of the present invention even though they are not clearly described or illustrated in the present specification. In addition, it is to be understood that all conditional terms and exemplary embodiments mentioned in the present specification are obviously intended only to allow those skilled in the art to understand a concept of the present invention in principle, and the present invention is not limited to exemplary embodiments and states particularly mentioned as such.

The abovementioned objects, features, and advantages will become more obvious from the following detailed description associated with the accompanying drawings. Therefore, those skilled in the art to which the present invention pertains may easily practice a technical idea of the present invention.

Further, in describing the present invention, when it is decided that a detailed description of the well-known technology associated with the present invention may unnecessarily make the gist of the present invention unclear, it will be omitted.

Hereinafter, various exemplary embodiments of the present invention will be described in detail with reference to the accompanying drawings.

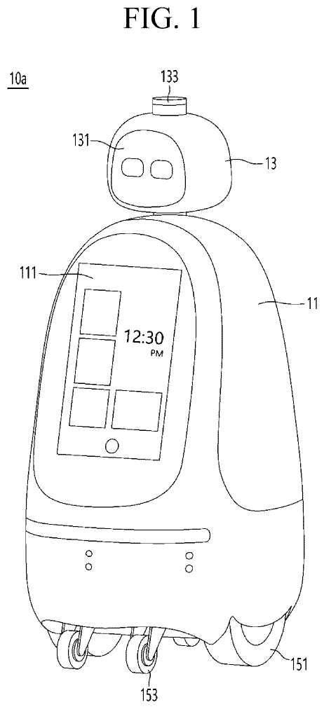

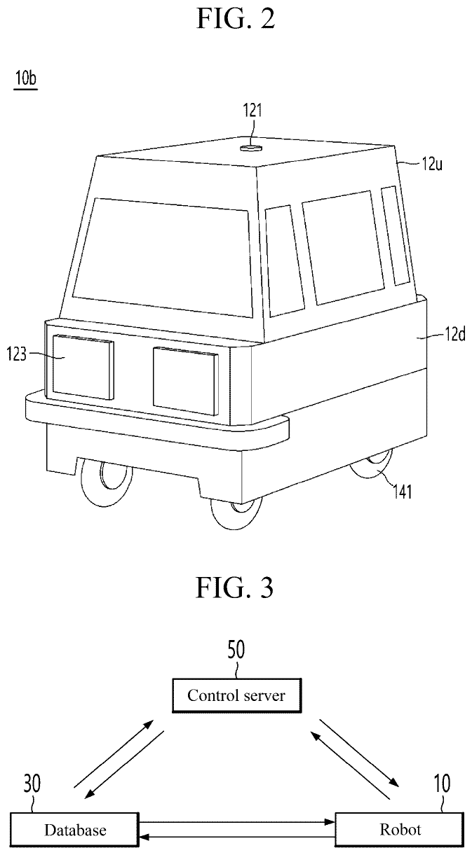

FIGS. 1 and 2 are drawings illustrating a robot 10 according to an exemplary embodiment of the present invention. Here, the robot 10 may be divided into a robot 10a that travels in an indoor environment and a robot 10b that travels in an outdoor environment.

For example, the robot 10a, which includes a display unit 111 provided on a front surface as in FIG. 1 and requires information exchange with a user, may be suitable for traveling in the indoor environment, and the robot 10b, which is sealed by a housing 12 as in FIG. 2 and does not include a separate display unit, may be suitable for traveling in the outdoor environment.

The robot 10a in FIG. 1 may include a body portion 11, traveling portions 151 and 153, and a head portion 13.

The head portion 13 may include a display unit 131 provided on a front surface of the head portion 13 to display information for communication with the user, and a sensor 133 may be provided at an upper portion of the head portion 13 to collect various information necessary for traveling of the robot 10a.

The body portion 11 may include the display unit 111 provided on a front surface of the body portion 11 to display information required by the user, a state of the robot, or the like. For example, the display unit 131 of the head portion may display information in the form of a feedback based on an input value of the user or an administrator, and the display unit 111 of the body portion may display a time, weather, information regarding a target space, the state of the robot, or the like and may display the above-described information in various ways according to a user operation.

The traveling portion according to the present exemplary embodiment may be provided in the form of wheels at a lower portion of the body portion 11, and may include a main wheel 151 that directly rotates by a motor, and an auxiliary wheel 153 that prevents the robot 10a from overturning and rotates by friction with a ground when the robot 10a moves.

The robot 10b in FIG. 2 may have a structure in which an internal configuration of the robot is firmly sealed by the housing 12, and unlike the robot 10a in FIG. 1, structures such as the display units 111 and 113 that are relatively weak in durability are omitted.

More specifically, the housing 12 may have a combined structure of an upper housing 12u and a lower housing 12d. A sensor 121 may be provided on an upper surface of the upper housing 12u, and a sensor 123 may also be provided on a front surface of the lower housing 12d. It is a matter of course that various types of sensors may be adopted for the sensors 121 and 123 depending on the purpose.

In addition, as described above, a wheel 141 as a traveling portion of the robot 10b according to the present exemplary embodiment for traveling in the outdoor environment may directly rotate by power transmission from the motor.

The robots 10a and 10b described above are illustrated for expressing the robot described below in the present exemplary embodiment, and are a type of robot included in a logic and system described below. Therefore, the present invention is not necessarily limited thereto.

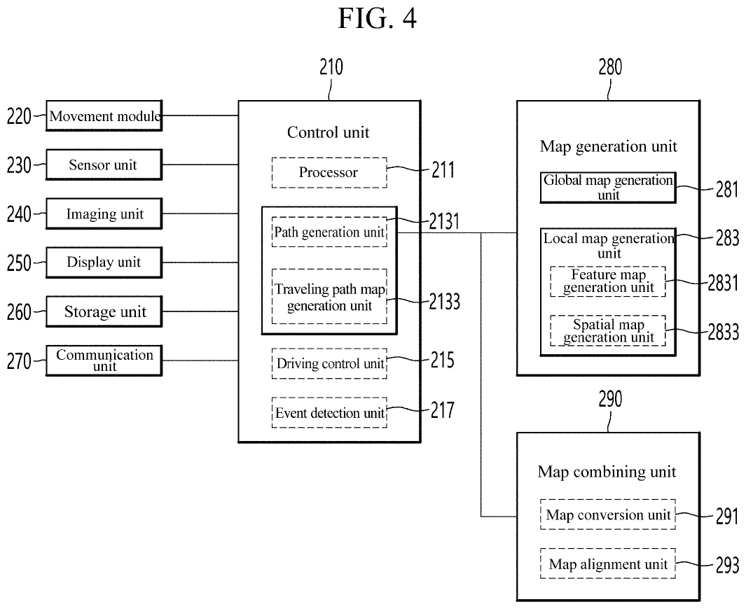

FIG. 3 is a diagram illustrating a configuration of a robot control system according to an exemplary embodiment of the present invention, and FIG. 4 is a diagram illustrating a configuration of the robot according to an exemplary embodiment of the present invention.

The following description will be made with reference to FIGS. 3 and 4.

The robot control system according to the present exemplary embodiment may include the robot 10, a database 30, and a server 50.

As described above, the robot 10 may include robots of various shapes and configurations that may travel indoors and £ outdoors, and may perform a task by transmitting and receiving information such as map information, traveling information, and traveling path information with the database 30 and the server 50.

Referring to FIG. 4, the robot 10 according to the present exemplary embodiment may include a control unit 210, a movement module 220, a sensor unit 230, an imaging unit 240, a display unit 250, a storage unit 260, a communication unit 270, a map generation unit 280, and a map combining unit 290.

First, the movement module 220 may include the motor, a gear assembly, and the wheels, and may provide a driving force for movement (traveling) of the robot 10.

Specifically, the motor may be a core component of the movement module and may transmit a direct driving force to the wheels of the robot, the gear assembly may appropriately convert a rotational force generated by the motor and transmit the converted force to the wheels, and the wheels may transmit such a driving force to the ground to move the robot in a desired direction.

The movement module 220 may be controlled based on a current flowing through the motor during traveling of the robot. The current flowing through the motor during traveling may change depending on a condition of the ground the robot encounters, a gradient, the presence or absence of an obstacle, and the like.

The sensor unit 230 may include various sensors that may acquire information regarding the target space during traveling of the robot in the target space. For example, the sensor unit 230 may include at least two or more of an image sensor, a light detection and ranging (LiDAR) sensor, and a radar sensor. Here, the target space may refer to a specific area or region where the robot 10 travels or performs a task. The target space may mainly refer to an indoor or outdoor space which is a physical place where the robot 10 needs to move, and may include a destination or a work environment where setting of a path of the robot, traveling of the robot, a task, and the like are performed.

Specifically, the sensor unit 230 may detect the condition (for example, asphalt road, concrete road, dirt road, sand road, gravel road, tile floor, or the like) of the floor (or ground) the robot encounters, the gradient, the presence or absence of an obstacle, and the like, by using the image sensor, the LiDAR sensor, and the radar sensor. For example, the LiDAR sensor may accurately detect a change in height of the floor or a position of an obstacle by emitting a laser beam and receiving a reflected signal. Additionally, the image sensor may collect visual information of the floor to recognize and analyze a surface condition of a path on which the robot travels, and the radar sensor may measure a distance and speed of an object or obstacle around the robot by using radio waves.

In addition, the sensor unit 230 may also have a function of detecting a change in current flowing through the motor during traveling. The current flowing through the motor may change depending on the condition of the floor the robot encounters or the gradient. For example, when the robot travels on a sloped floor or an uneven floor, a load on the motor may increase and the current may increase accordingly. The sensor unit 230 may detect and analyze such a current change in real time.

In addition, the sensor unit 230 may include various sensors for measuring the state of the robot 10, and may generate state data regarding the state of the robot 10 by using the sensors. For example, the state data may include a battery state (for example, a temperature or a remaining battery level), a motor state, position information (for example, a current position, an inclination, or an acceleration), temperature information, and vibration information.

The imaging unit 240 may include a visible image sensor unit (not illustrated) for capturing a visible image, a thermal image sensor unit (not illustrated) for acquiring a thermal image, or the like. For example, the visible image sensor unit (not illustrated) may be implemented by an RGB camera, and the thermal image sensor unit (not illustrated) may be implemented by an infra-red camera. With such a configuration of the imaging unit 240, the robot 10 may accurately identify objects not only in a high-luminance environment such as during a daytime, but also in a low-luminance environment such as during a nighttime.

The display unit 250 may display the state of the robot 10, a time, weather, the information regarding the target space, or the like. In the robot control system according to the present exemplary embodiment, for example, in a case where the robot 10 is not able to travel or perform a task due to an event, the robot 10 may transmit state information of the robot 10 to the server 50 and then display at least a part of the state information of the robot 10 on the display unit 250 and wait until a worker arrives at a location where the state information is transmitted to the server 50 and inputs a separate command.

That is, the display unit 250 may display a general state of the robot, information required for the task, and information to be provided to the user or worker, and it is a matter of course that the display unit 250 may also display information required for the robot control system.

The storage unit 260 may store various data required for an operation of the robot 100 or various data generated during an operation, and may store various data received from the outside. For example, the storage unit 260 may store a program for the operation of the robot 100, the map information, a captured image, a scenario for performing a task, and the like.

In addition, the storage unit 260 may store floor data including the floor condition, the gradient, and the presence or absence of an obstacle, or the state data of the robot 10 acquired in real time.

The communication unit 270 may include one or more modules that enable the robot 10 to communicate with other devices (for example, a remote control system, the server 50, another robot, and the database 30). For example, the communication unit 270 may receive real-time weather information of the current position or destination of the robot 10 from an external server.

In addition, the communication unit 270 may include a GPS module, and the communication unit 270 may receive a signal from a satellite to determine the current position of the robot 10.

Meanwhile, the control unit 210 may include a processor 211, a path generation unit 2131, a traveling path map generation unit 2133, a driving control unit 215, and an event detection unit 217.

The processor 211 may process information acquired from various components included in the robot described above.

The path generation unit 2131 and the traveling path map generation unit 2133 may select one of maps formed by aligning (combining) at least two different formats of maps generated by the map generation unit 280, and the path generation unit 2131 may generate a traveling path of the robot within the selected map, or the traveling path map generation unit 2133 may generate a traveling path map to be used by the robot based on the generated traveling path.

The above-described traveling path map means a simplified map including nodes, edges, and context information included in each node or edge generated according to an example described below, the node may represent an object that is a task execution target of the robot or a point where a change in the state of the robot (for example, a change in traveling direction) occurs on the traveling path, the edge may connect the nodes and represent the traveling path of the robot between the nodes, and the context information may represent a control command value of the robot at the node or edge, information regarding the node, or the like.

Meanwhile, the path generation unit 2131 may generate a traveling path between objects based on a map generated by a global map generation unit 281, and may generate a path based on a map generated by a local map generation unit 283 in the vicinity of an object (a predetermined region around the object), thereby more effectively generating the traveling path, and likewise, when modifying the generated traveling path for other reasons, it may be possible to quickly respond to the other reasons by modifying the traveling path according to the exemplary criteria described above.

In addition, for example, the path generation unit 2131 may generate a plurality of traveling path candidates for the robot 10 to perform a task in the target space (map information), and select an optimal traveling path from among the generated traveling path candidates according to a preset criterion, thereby generating an optimal traveling path for the robot 10.

The preset criterion may be whether or not a monitoring blind spot occurs for an object when performing an assigned task (traveling) according to a monitoring priority set for objects existing on the map information according to the task of the robot 10.

Further, the path generation unit 2131 may generate an optimal traveling path of the robot based on the floor condition.

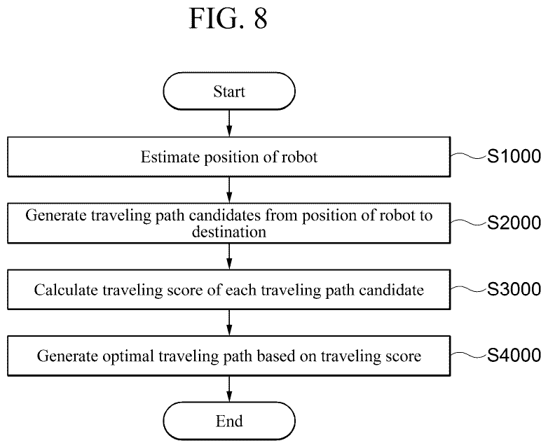

Specifically, the path generation unit 2131 may estimate the position of the robot, generate a plurality of path candidates from the position of the robot to a destination, calculate traveling scores for the traveling path candidates, and generate an optimal traveling path based on the traveling scores. This will be described below with reference to FIGS. 8 to 10.

Meanwhile, the driving control unit 215 may generate or transmit a signal for controlling the movement module 220. More specifically, the signal for controlling the movement module 220 may be generated according to a control signal input from the server 50 through the communication unit 270, or the signal for controlling the movement module 220 may be generated based on a processing result of the processor 211 based on the information regarding the target space acquired from the sensor unit 230 or the imaging unit 240.

In addition, the driving control unit 215 may generate a control signal to provide an optimal driving force for the moving module 220 according to a real-time current change analyzed by the processor 211.

For example, when a current increases above a certain level, the robot may be in a situation where the robot receives a high resistance (for example, a slope or uneven ground), and thus, a gear ratio may be adjusted accordingly or a rotation speed of the motor may be adjusted to enable stable traveling.

The event detection unit 217 may detect an abnormal situation occurring in one of objects existing in the target space, an abnormal situation occurring on the traveling path of the robot, or an abnormal situation occurring in the robot, through the sensor unit 230, the imaging unit 240, the communication unit 270, and the process 211.

The map generation unit 280 may digitize the target space where the robot 10 travels into various formats and then generate a map for each format, and the map combining unit 290 may perform conversion and alignment of the maps generated in each format.

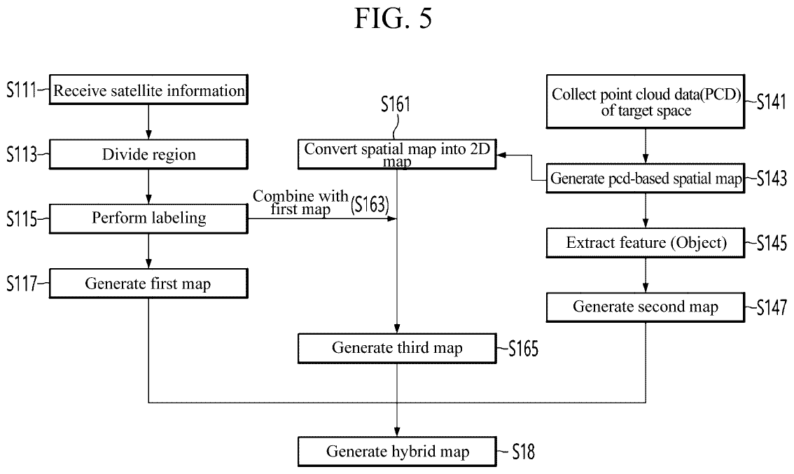

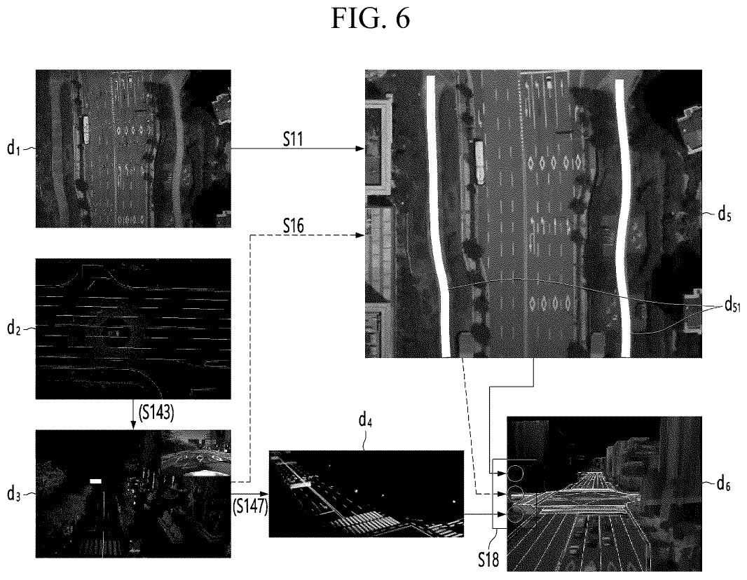

This will be described in more detail with reference to examples of FIGS. 5 and 6 below.

Meanwhile, the database 30 may store in advance the map information of the target space, a plurality of scenarios, traveling paths, and information regarding a type of an event, or the like. For example, the map information may include various map information for expressing the target space, and may include, for example, a satellite map (two-dimensional (2D) map), simultaneous localization and mapping (SLAM) information, point cloud data (PCD), a topological map, a semantic map, a high-definition (HD) map, or the like for the target space.

The server 50 may transmit the map information to the robot 10 or may assign a task to the robot 10 or control the robot 10 according to an assigned task.

It is a matter of course that the server 50 may also serve as an information relay point between the robot 10 and the database 30 in the robot control system, and some of the vehicle event type confirmation, map information transmission, robot control command transmission, and the like described above may be performed in the database 30 or through a component mounted on the robot 10.

FIG. 5 is a diagram illustrating a map generation method according to an exemplary embodiment of the present invention, and FIG. 6 is a diagram illustrating some of maps described in FIG. 5.

The following description will be made with reference to FIGS. 4 to 6.

In the present exemplary embodiment, a map used by the robot 10 to perform a task may be a map (hereinafter, referred to as a hybrid map) in which maps of different formats are combined (overlapping and stacked), and may be divided into a global map and a local map depending on the form of the map.

The global map may mean a 2D map generated by the global map generation unit 281 based on a satellite map received from the communication unit 270 or the database 30, and the local map may mean a three-dimensional (3D) map (spatial map or feature map) generated by the local map generation unit 283 based on point cloud information (point cloud data (PCD)) received from the communication unit 270 or the database 30.

It is a matter of course that the point cloud information required for the generation of the local map may be collected through the sensor unit 230 during the traveling of the robot 10 for mapping the target space and may be stored in advance in the storage unit 260.

The map combining unit 290 may generate the hybrid map by using maps of different formats. More specifically, the map combining unit 290 may include a map conversion unit 291 and a map alignment unit 293. The map conversion unit 291 may convert one of the different formats of the maps into a reference format based on the other format to generate a specific map, and the map m alignment unit 293 may generate the specific map by overlapping the maps converted into the same format.

It is a matter of course that the map alignment unit 293 may also generate a single map by overlapping map information of different formats as described above. For example, objects that are task targets may be expressed as the nodes based on the global map, and detailed information of the objects expressed as the respective nodes may overlap with information of the local map to generate the hybrid map.

Referring to FIG. 5, a series of processes classified as step S11 (S111 to S117) for generating a first map represents a process for generating the global map described above, a series of processes classified as step S14 (S141 to S147) represents a process for generating the local map, and a series of processes classified as step S16 (S161 to S165) represents a process for converting some information into a 2D map during the local map generation process and generating an intermediate map by combining necessary information with the first map.

More specifically, in the process for generating the global map, the robot 10 may perform reception (S111) of the satellite information from the database 30 or the server 50 through the communication unit 270.

The satellite information may include aerial photographs, orthophotos, and true orthophotos of the target space, and may be expressed as photographs or images, such as di in FIG. 6, for example.

After receiving the satellite information, the global map generation unit 281 may perform division (S113) of a region based on the received satellite information and perform labeling (S115) to generate the first map (S117).

More specifically, information included in 2D layout data, such as a boundary of a road, a boundary of a building, or a road (d₅₁) usable by the robot, may be expressed as in ds, for example, by dividing the region (S113), and the labeling (S115) may be performed by inputting the context information for each divided region, necessary region, or the expressed information, for example.

The 2D map generated through the above described process may be referred to as the first map (ds) in the present exemplary embodiment.

Next, in the process for generating the local map, the robot 10 may perform collection (S141) of the point cloud information of the target space, which may be expressed as de in FIG. 6, for example. The collection may mean various methods of acquiring the point cloud information (3D data), as described above.

Meanwhile, a spatial map generation unit 2833 may generate a spatial map (d₃) based on the point cloud information. Briefly explaining the generation of the spatial map, the spatial map (d₃) may be generated through post-processing of acquired raw data (the PCD or 3D data). For example, after performing outlier removal (noise removal) on acquired raw information, data sets may be aligned and combined and then subjected to rendering.

After a series of processes for generating the spatial map is performed, or during the series of processes, a feature map generation unit 2831 may perform generation (S147) of a feature map (d₄) through a step (S145) of extracting features of objects. At this time, in the feature map, floor data including the condition of the ground, the gradient, the presence of absence of an obstacle, and a friction coefficient may be associated with each position on the map based on data acquired by multiple sensors.

That is, the 3D map generated through the above-described process may be referred to as a second map (d₄) in the present exemplary embodiment.

Meanwhile, the map combining unit 290 may perform conversion (S161) of the spatial map generated based on the PCD into the 2D map through the map conversion unit 291, and then perform combination (S163) of the converted map with the first map through the map alignment unit 293 to generate a third map (d₅) (S165).

The third map may express some of information not expressed in the satellite information by overlapping the 2D map converted from the spatial map (3D data) on the first map generated based on the satellite information (2D layout data). Therefore, in FIG. 6, the first map and the third map are expressed as ds for convenience.

Meanwhile, the control unit 210 may generate the hybrid map (d₆) (S18) by combining the first map, the second map, and the third map through the map generation unit 280 and the map combining unit 290.

According to various exemplary embodiments of the present invention, the hybrid map may also be formed by combining the second map and the third map.

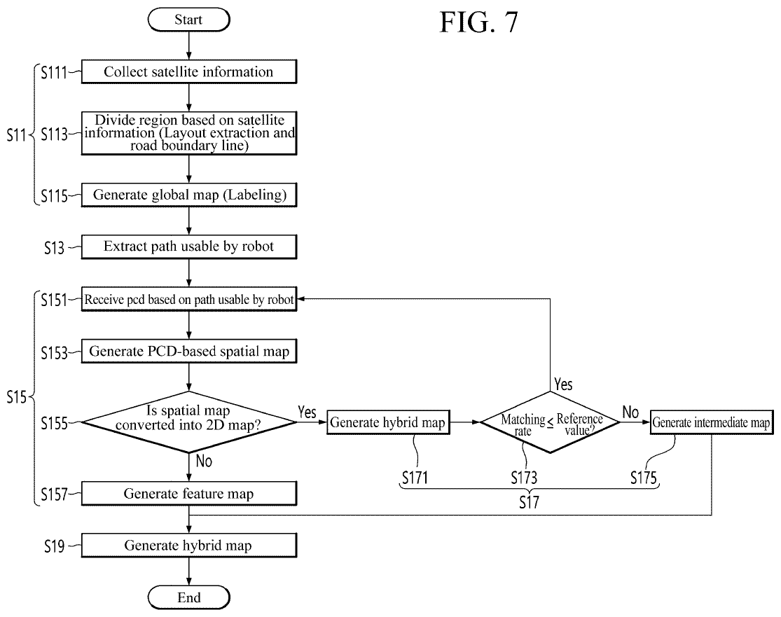

FIG. 7 is a diagram illustrating a map generation method according to an exemplary embodiment of the present invention.

Hereinafter, a description will be made with reference to FIG. 7, but the above-described contents will be omitted.

The robot 10 according to the present exemplary embodiment may perform generation (S11) of the global map by using the above-described configuration and method, and the path generation unit 2131 may perform extraction (S13) of a path (d₅₁ of FIG. 5) usable by the robot 10 based on the generated global map.

For example, the path usable by the robot 10 may be set to a region that includes a part of a boundary between a region where a vehicle travels and a region where a person may pass.

Further, the robot 10 may perform reception (S151) of the PCD stored in the database 30 through the communication unit 270. More specifically, the reception of the PCD may be based on the path usable by the robot 10, the path being extracted in the step (S13).

That is, the traveling path of the robot or the map may be more effectively generated by receiving the PCD on the path usable by the robot, rather than receiving a large amount of PCD for the target space.

Meanwhile, the spatial map generation unit 2833 may perform generation (S153) of a PCD-based spatial map, and in a case where the generated spatial map is converted into the 2D map by the map conversion unit 291 (S155: Yes), the map alignment unit 293 may combine the converted 2D map and the map (first map or global map) generated in the step (S11) to generate the hybrid map (S171).

The hybrid map generated in the step (S171) is referred to as a hybrid map in the sense that two maps containing different information overlap each other, and it is obvious that information included is different from that of the hybrid map generated in step S19.

After the step (S171), the map alignment unit 293 may compare a matching rate (the degree of overlap) of the two maps with a reference value, and in a case where the matching rate exceeds the reference value (S173: No), the two overlapping maps may be aligned to generate the intermediate map (S175).

Alternatively, for example, the hybrid map generated in the step (S171) may mean a map in which two maps (the first map and the converted 2D map) containing different information overlap each other, and in this case, when the matching rate (the degree of overlap) is compared with the reference value in the step (S173), and the matching rate exceeds the reference value (S173: No), the intermediate map in step S175 may mean the map already generated in the step (S171).

The degree of overlap may be determined based on elements (for example, a boundary of the path used by the robot) commonly included in the first map (a 2D layout data map based on the satellite information) and the 2D map converted from the spatial map (3D Data).

Meanwhile, in a case where the spatial map generated in the step (S155) is not converted into the 2D map (S155: No), the feature map generation unit 2831 may extract the features of the objects in the spatial map to generate the feature map (S157), which is as described above.

Further, the control unit 210 may generate the hybrid map (S19) by combining two or more maps generated by the map generation unit 280 and the map combining unit 290 through the above-described process.

Next, a method for generating an optimal path of the robot 10 based on the floor condition will be described with reference to FIG. 8.

FIG. 8 is a flowchart illustrating the method for generating an optimal path based on the floor condition according to an exemplary embodiment of the present invention.

Referring to FIG. 8, the robot 10 may estimate the current position of the robot based on various data (S1000).

Specifically, the robot 10 may utilize a GPS signal to estimate the current position. However, the robot 10 may additionally utilize various sensor data to compensate for errors of the GPS signal or reliability degradation.

For example, the robot 10 may estimate the current position of the robot 10 by comparing a surrounding image of the robot 10 captured by the imaging unit 240 with the second map or hybrid map described above. Here, the robot 10 may estimate the exact current position of the robot 10 by comparing a building exterior or landmark image in the surrounding image with those in the second map.

As another example, the robot 10 may estimate the current position of the robot 10 by comparing the condition of the ground on which the robot is currently positioned, the gradient, and the presence or absence of an obstacle, which are detected by the sensor unit 230, with those in the third map or hybrid map described above.

That is, the robot 10 may determine the current position based on the GPS signal and may finely correct (or adjust) the current position by using other data (for example, an image or sensing data).

In addition, when estimating the current position, the robot 10 may set a region based on the GPS signal instead of comparing the entire map, and use the second map, the third map, or the hybrid map corresponding to the set region. By doing so, the position estimation process may be performed more quickly and efficiently.

Next, the robot 10 may generate one or more traveling path candidates from the estimated current position to a destination (S2000). Here, the destination may mean the final position or point to which the robot is to move, and the traveling path candidate may mean one of several possible paths that the robot may select to move from the estimated current position to the destination.

Specifically, the robot 10 may generate the traveling path candidate of the shortest distance that minimizes a distance between the estimated current position and the destination based on the hybrid map. At this time, the robot 10 may generate the traveling path candidate by considering time efficiency, battery efficiency, safety, or the like.

For example, the robot 10 may generate the traveling path candidate by giving priority to a path with fewer obstacles and smooth traffic to minimize a traveling time.

As another example, the robot 10 may generate the traveling path candidate that follows a flat road with a low gradient and low energy consumption to optimize a battery usage time.

As another example, the robot 10 may generate the traveling path candidate that avoids complex intersections or areas with frequent contact with people to ensure traveling stability.

In addition, the robot 10 may also generate the traveling path candidate by considering real-time weather information. For example, when it is raining heavily or snowing heavily, the robot 10 may generate the safer traveling path candidate that avoids a slippery road or flooded area, and when there is a strong wind, the robot 10 may generate the traveling path candidate by giving priority to a path that is less affected by the wind.

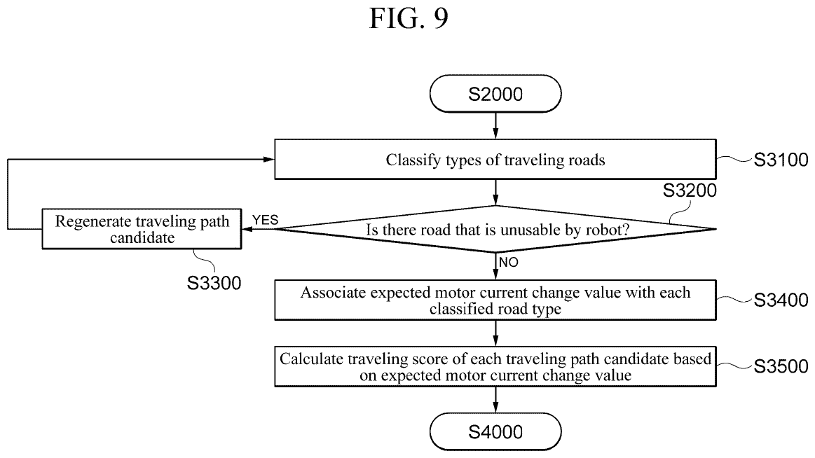

Next, the robot 10 may calculate traveling scores for the generated traveling path candidates (S3000). Specifically, the robot 10 may analyze a level of traveling difficulty and energy efficiency of the traveling path candidate based on a motor current change value, and calculate the traveling score by comprehensively considering various factors such as time efficiency and safety. This will be described with reference to FIG. 9.

FIG. 9 is a flowchart illustrating the method for generating an optimal traveling path based on the floor condition according to an exemplary embodiment of the present invention in more detail.

Referring to FIG. 9, the robot 10 may classify types of traveling roads included in the traveling path candidates (S3100). Here, the traveling road means a road on which the robot 10 actually travels when moving, and each traveling path candidate may be a combination of various types of traveling roads.

Specifically, the robot 10 may classify the traveling roads included in the traveling path candidates by type based on the hybrid map. Here, the types of the traveling roads may be classified into a lane, a centerline, a boundary line, a robot road (including a traveling path line, a curb, and a walking line), a road around a facility, and a road around a waypoint.

For example, the robot 10 may distinguish major roads and sidewalks by using the global map, and may distinguish an accurate boundary line by combining curb or walking line information with the local map to classify the traveling roads within the traveling path candidates by type.

That is, the robot 10 may classify the traveling roads included in the traveling path candidates by type by supplementing the information of the global map using the local map. In this manner, the traveling roads of each traveling path candidate may be classified by type.

Next, the robot 10 may determine whether or not there is a road that is unusable by the robot 10 among the classified types of the roads (S3200). Here, the road that is unusable may mean a road that is not suitable or safe for the robot to travel, and may include a road through which the robot 10 may not pass or on which it is difficult for the robot 10 to travel (for example, an excessively narrow road, rough terrain, stairs, steep slope, a sidewalk, or a slippery road) when considering physical characteristics of the robot, traveling ability, safety, or the like.

Such a road that is unusable may be determined differently depending on the state of the robot 10 (for example, a battery or a tire condition). For example, when the tire condition of the robot 10 is good, the robot 10 may safely travel on a slippery road or rough terrain, but when the tire is worn or damaged, such a road may be dangerous and may be determined as the road that is unusable.

That is, the robot 10 may determine whether or not a type of road classified as the road that is unusable by the robot 10 is included in the traveling path candidate.

In a case where the road that is unusable by the robot 10 is included in the traveling path candidate (S3200: YES), the robot 10 may generate a new traveling path candidate instead of the corresponding traveling path candidate (S3300). Here, the new traveling path candidate is referred to as a second traveling path candidate, and the existing traveling path candidate is referred to as a first traveling path candidate.

Then, the robot 10 may perform the traveling road type classification step (S3100) again for the second traveling path candidate. At this time, in a case where only a few traveling path candidates among the first traveling path candidates include the road that is unusable, the robot 10 may perform an association step (S3400) after excluding the corresponding traveling path candidates.

Meanwhile, in a case where the road that is unusable by the robot 10 is not included in the traveling path candidates (S3200: NO), the robot 10 may associate an expected motor current change value of the robot 10 with each classified road type in the traveling path candidates (S3400). Here, the robot 10 may calculate the expected motor current change value of the robot 10 during traveling on each traveling path candidate based on the floor data associated with the hybrid map, and associate the expected motor current change value to each traveling path candidate. At this time, the hybrid map in which the global map (for example, the satellite map) and the local map (for example, 3D point cloud) are combined may include information such as a gradient of the road, a surface condition (asphalt, gravel, mud, or the like), and an obstacle position.

Specifically, the robot 10 may calculate the expected motor current change value by reflecting a current change of the motor according to the floor of the traveling path candidate, and the calculated expected motor current change value may be associated with the corresponding traveling path candidate. Here, the expected motor current change value may mean an expected value of a change of a current of the motor from a basic current value according to a traveling condition when the robot 10 travels on a specific traveling path, and may be expressed as a percentage value.

For example, in the case of a flat asphalt path with no slope, the expected motor current change value may be calculated as 2%, and in the case of a path with a gradient of 10% and a gravel road, the expected motor current change value may be calculated as 20%.

In addition, the robot 10 may also calculate the expected motor current change value by considering weather information for each traveling path candidate.

For example, the robot 10 may calculate the expected motor current change value as 10% for a flat asphalt road section in the traveling path candidate on a rainy day, and may calculate the expected motor current change value as 15% for a flat road section in the traveling path candidate on a windy day.

That is, the robot 10 may calculate the expected motor current change value by considering a frictional resistance change in the traveling path candidate according to weather.

Next, the robot 10 may calculate the traveling scores of the plurality of traveling path candidates based on the expected motor current change value (S3500).

Specifically, the robot 10 may calculate a current consumption of the traveling path candidate based on the motor current change value associated with each traveling path candidate. For example, the robot 10 may calculate the current consumption of the robot 10 for each traveling path candidate by applying the expected motor current change value to the basic current value and then reflecting a distance and traveling time of the traveling path candidate. Here, the basic current value may mean a current consumed when the robot 10 travels on a flat road.

Then, the robot 10 may calculate the traveling score each traveling path candidate by using the calculated current consumption (energy efficiency) of each traveling path candidate, the traveling time (time efficiency) of each path candidate, safety, or the like as evaluation elements. At this time, the robot 10 may calculate the traveling score of the traveling path candidate by assigning a relative score to each evaluation element.

In addition, the robot 10 may calculate the traveling score Of the traveling path candidate by reflecting a weight on the evaluation element. Here, the weight may be variably determined according to, for example, the scenario, the purpose, or the state of the robot 10.

Referring back to FIG. 8, the robot 10 may generate an optimal path among the traveling path candidates based on the traveling score (S4000).

Specifically, the robot 10 may select the traveling path candidate with the highest traveling score among the traveling path candidates as the optimal traveling path, and the robot 10 may travel along the selected traveling path.

In addition, in a case where an unexpected situation (for example, a sudden change in weather) occurs during traveling of the robot 10 along the selected optimal path, the robot 10 may generate (or select) a new optimal traveling path by performing the robot position estimation step (S1000) again.

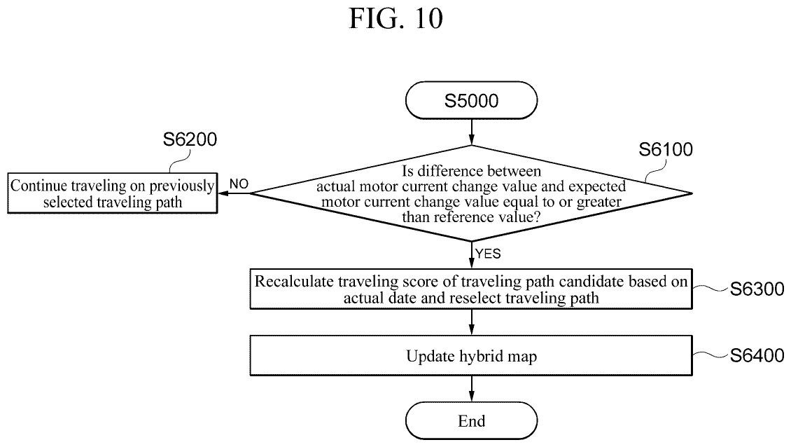

Meanwhile, in a case where an actual motor current change value during traveling is partially different from the expected motor current change value, selection of an optimal traveling path may be performed again by reevaluating the traveling score of the previously generated traveling path candidate rather than immediately recalculating a path. This will be additionally described with reference to FIG. 10.

FIG. 10 is a flowchart illustrating the method for generating an optimal path based on the floor condition according to an exemplary embodiment of the present invention.

Referring to FIG. 10, the robot 10 may determine whether or not a difference between the actual expected motor current change value and the expected motor current change value is equal to or greater than a preset reference value (S6100).

Specifically, the robot 10 may monitor the actual motor current change value measured by the sensor unit 230 in real time during traveling, compare the actual motor current change value with the expected motor current change value calculated by analyzing the traveling path in advance, and determine whether or not the difference is equal to or greater than the reference value.

Then, in a case where the difference is not equal to or greater than the reference value (S6100: NO), the robot 10 may determine that the traveling condition has not changed and continue traveling on the previously selected optimal traveling path (S6200).

In a case where the difference is equal to or greater than the reference value (S6100: YES), the robot 10 may recalculate the traveling scores of the previously generated traveling path candidates based on actual data and reselect an optimal traveling path (S6300).

Specifically, the robot 10 may recalculate the traveling scores of the previously generated traveling path candidates by using the actually measured motor current change value, the change in traveling condition, or the like, and reselect an optimal path from among the traveling path candidates based on the recalculated traveling scores. At this time, among the previously generated traveling path candidates, a traveling path candidate that is unusable from the position of the robot 10 (for example, a traveling path candidate that is not accessible or travelable from the current robot position) may be excluded from recalculation targets.

That is, the robot 10 may not reevaluate a traveling path candidate that the robot may not pass due to a road blockage or an obstacle, and may select an optimal path only from traveling path candidates that are travelable from the current position of the robot 10 and continue traveling.

In addition, the robot 10 may update the hybrid map for a region where the actual data is measured to be different (S6400).

Specifically, the robot 10 may modify data associated with a corresponding region of the existing hybrid map based on data such as the floor condition, the gradient, the presence or absence of an obstacle, or the motor current change value measured from the actual traveling path.

Meanwhile, the above-described method for generating an optimal path of the robot based on the floor condition has been described based on a case where the method is executed by the robot 10 itself (specifically, the path generation unit 2131). However, the above-described method for generating an optimal traveling path may be executed by a control server 50 in addition to the robot 10, and the robot 10 may transmit real-time data to the control server 50 and receive an optimal path from the control server 50. In this case, the control server 50 may include a control unit, a map generation unit, a map combining unit, and various device components that execute the same functions as those of the robot 10.

According to the present invention described above, real-time weather information or a road condition may be reflected when generating a path, and thus, a slippery road or flooded area caused by rain, snow, wind, r the like may be avoided, thereby improving traveling safety.

In addition, the present invention may estimate an accurate position by utilizing various sensor data (for example, a captured image and a floor condition detected by the sensor unit) in addition to a GPS signal.

Further, the present invention may accurately predict a motor current consumption by considering changes in floor condition, gradient, weather, or the like on the path, and select an optimal path based on the predicted motor current consumption.

Moreover, the present invention may variably apply a weight to each evaluation element, so that a path selection criterion may be dynamically adjusted according to a situation or a state of the robot, thereby making it possible to select an optimal path under a specific condition.

Various exemplary embodiments described herein may be implemented in computer-readable recording medium using, for example, software, hardware, or a combination thereof.

According to a hardware implementation, the exemplary embodiments described herein may be implemented using at least one of application specific integrated circuits (ASICs), digital signal processors (DSPs), digital signal processing devices (DSPDs), programmable logic devices (PLDs), field programmable gate arrays (FPGAS), processors, controllers, micro-controllers, microprocessors, or electric units for performing other functions. In some cases, the exemplary embodiments described in the present specification may be implemented as a control module itself.

According to software implementation, exemplary embodiments such as procedures and functions described in the present specification may be implemented as separate software modules. Each of the software modules may perform one or more functions and operations described in the specification. A software code may be implemented as a software application written in a suitable programming language. The software code may be stored in a memory module and executed by a control module.

The technical spirit of the present invention has been described only by way of example hereinabove, and the present invention may be variously modified, altered, and substituted by those skilled in the art to which the present invention pertains without departing from essential features of the present invention.

Accordingly, the exemplary embodiments disclosed in the present invention and the accompanying drawings are provided in order to describe the technical spirit of the present invention rather than limiting the technical spirit of the present invention, and the scope of the present invention is not limited by these exemplary embodiments and the accompanying drawings. The scope of the present invention should be interpreted by the following claims and it should be interpreted that all spirits equivalent to the following claims fall within the scope of the present invention.

1. A method for generating an optimal traveling path of a robot based on a floor condition, the method comprising:
generating a plurality of traveling path candidates from a position of the robot to a destination;
calculating traveling scores of the traveling path candidates; and
generating the optimal traveling path based on the traveling scores.

2. The method of claim 1, wherein the calculating of the traveling scores includes classifying types of traveling roads included in the traveling path candidates.

3. The method of claim 2, wherein the calculating of the traveling scores further includes determining whether or not there is a road that is unusable by the robot among the classified types of traveling roads.

4. The method of claim 3, wherein the calculating of the traveling scores further includes regenerating a traveling path candidate based on whether or not there is a road that is unusable by the robot in the traveling path candidates.

5. The method of claim 4, wherein the calculating of the traveling scores further includes associating an expected motor current change value of the robot with each classified type of traveling road.

6. The method of claim 5, wherein the calculating of the traveling scores further includes calculating the traveling scores of the traveling path candidates based on the expected motor current change value.

7. A robot that generates an optimal traveling path based on a floor condition, the robot comprising:
a path generation unit generating a plurality of traveling path candidates from a position of the robot to a destination, calculating traveling scores of the traveling path candidates, and generating the optimal traveling path based on the traveling scores.

8. The robot of claim 7, wherein the path generation unit classifies types of traveling roads included in the traveling path candidates.

9. The robot of claim 8, wherein the path generation unit determines whether or not there is a road that is unusable by the robot among the classified types of traveling roads.

10. The robot of claim 9, wherein the path generation unit regenerates a traveling path candidate based on whether or not there is a road that is unusable by the robot in the traveling path candidates.

11. The robot of claim 10, wherein the path generation unit associates an expected motor current change value of the robot with each classified type of traveling road.

12. The robot of claim 11, wherein the path generation unit calculates the traveling scores of the traveling path candidates based on the expected motor current change value.

13. A computer-readable recording medium storing a program for executing the method according to any claim 1.

14. A program stored in a computer-readable recording medium and including a program code for executing the method according to claim 1.
